(19) United States
(12) Patent Application Publication
(10) Pub. No.: US 2023/0131474 A1
(43) Pub. Date: Apr. 27, 2023

(54) AUGMENTED REALITY MARINE NAVIGATION

(71) Applicants: Samuel R. Pecota, Elk Grove, CA (US); Eric Holder, Sierra Vista, AZ (US)

(72) Inventors: Samuel R. Pecota, Elk Grove, CA (US); Eric Holder, Sierra Vista, AZ (US)

(21) Appl. No.: 17/958,104

(22) Filed: Sep. 30, 2022

Related U.S. Application Data
(63) Continuation of application No. 17/073,089, filed on Oct. 16, 2020, now abandoned.
(60) Provisional application No. 62/916,130, filed on Oct. 16, 2019.

(51) Int. Cl. G01C 21/20; G06F 3/04842; G06F 3/16; G06F 3/01; G09G 5/377; G02B 27/01

(52) U.S. Cl. CPC G01C 21/203; G06F 3/04842; G06F 3/167; G06F 3/013; G09G 5/377; G02B 27/0172; G06F 3/017; G02B 2027/014; G09G 2354/00; G02B 2027/0178

(57) ABSTRACT

Systems and methods for augmented-reality-based marine navigation. An electronic controller plots a navigational route between a current geospatial position of a host vessel and a target destination of the host vessel. The navigational route is plotted as a series of waypoints. The electronic controller receives an electronic transmission from at least one nearby ship indicative of a current position of the at least one nearby ship (e.g, an MS transmission) and updates the navigational route based at least in part on the received electronic transmission. A graphical representation of the updated navigational route and a graphical indication of the current position of the at least one nearby ship (e.g., a conformal overlay of the at least one nearby ship) are then displayed on a head-worn augmented reality display device.

### RELATED APPLICATION

This application is a continuation of U.S. patent application Ser. No. 17/073,089, filed Oct. 16, 2020, which claims the benefit of U.S. Provisional Patent Application No. 62/916,130, filed on Oct. 16, 2019, the entire contents of each of which are incorporated herein by reference.

### BACKGROUND

The present invention relates to systems and methods for marine navigation. In particular, the examples described in this disclosure relate to method for providing visualization and guidance for marine navigation and for automated or semi-automated operation of marine vessels.

### SUMMARY

In one embodiment, the invention provides an augmented reality marine navigation system including a wearable display device and an electronic controller configured to display computer-generated graphical elements overlaid onto a real-world field of view. The electronic controller is further configured to receive information from one or more other marine vessels (for example, automatic identification system (AIS) data) including a unique identification of the one or more other marine vessels and a position, course, and/or speed of the one or more other marine vessels. The electronic controller is also configured to display on the wearable display device graphical elements indicative of a navigational path for a host marine vessel overlaid onto the real world field of view and a conformal overlay of at least one other marine vessel in real world field of view of the wearable display device. The electronic controller is configured to determine and position the conformal overlay based at least in part on the information received from the one or more other marine vessels.

In some embodiments, the electronic controller is configured to automatically calculate a navigational path/route for the host vessel based at least in part on one or more waypoints. In some such embodiments, the electronic controller is also configured to determine an intended route of at least one other marine vessel based at least in part on the information received from the one or more other marine vessels and to update the calculated navigational path/route for the host vessel based on the estimated intended route of the at least one other marine vessel.

In another embodiment, the invention provides a system for augmented reality presentation of maritime navigation information to be overlaid on a view of the outside environment. The system will integrate information from various systems, including the automatic conversion of Electronic Chart System information into 3D conformal images; other vessel information (e.g. route data via data exchanges like the Automatic Identification System) and be integrated to portray navigational information and support for Rules of the Road and collision avoidance decision making. The system is configured to promote the mariners situational awareness by reducing head down time and yet maintaining a clear view out the window to the outside world. In some implementations, display clutter is reduced by only presenting core information required by the voyage stage, task and context. The system is configured to acquire this task and contextual information from a combination of pre-programmed intelligence, the use of data provided by ship systems, and timely and user-friendly mariner input.

In one embodiment, the invention provides a method for augmented-reality-based marine navigation. An electronic controller plots a navigational route between a current geospatial position of a host vessel and a target destination of the host vessel. The navigational route is plotted as a series of waypoints. The electronic controller receives an electronic transmission from at least one nearby ship indicative of a current position of the at least one nearby ship (e.g, an AIS transmission) and updates the navigational route based at least in part on the received electronic transmission. A graphical representation of the updated navigational route and a graphical indication of the current position of the at least one nearby ship (e.g., a conformal overlay of the at least one nearby ship) are then displayed on a head-worn augmented reality display device.

In another embodiment, the invention provides an augmented-reality-based marine navigation system comprising a head-worn augmented reality display device and an electronic controller. The head-worn augmented reality display device includes an at least partially transparent display screen configured to display graphical and textual elements visible over a real-world field of view. The electronic controller is configured to plot a navigational route between a current geospatial position of a host vessel and a target destination of a host vessel, wherein the navigational route is plotted as a series of waypoints. The electronic controllers receives electronic transmissions from at least one nearby ship indicating a current position of the at least one nearby ship (e.g., an AIS transmission) and updates the navigational route based at least in part on the electronic transmission. The electronic controller then causes the head-worn augmented reality display device to display a graphical representation of the updated navigational route and a graphical indication of the current position of the at least one nearby ship (e.g., as a conformal overlay of the at least one nearby ship).

Other aspects of the invention will become apparent by consideration of the detailed description and accompanying drawings.

### BRIEF DESCRIPTION OF THE DRAWINGS

FIG. 1 is a block diagram of a system for generating and positioning graphical elements displayed on a wearable display device in an augmented reality marine navigation system according to one embodiment.

FIG. 2 is an example of a real-world field-of-view visible through a transparent display of the wearable display device of FIG. 1 with graphical and textual elements displayed overlaid onto the real-world field-of-view.

FIG. 3 is a table of function calls for the augmented reality marine navigation system and an illustration of the expected output shown on the wearable display device according to one example.

FIG. 4 is a flowchart of a method for automatically determining and updating a navigational route for a host vessel based at least in part on an estimated route for at least one other marine vessel.

FIG. 5 is a flowchart of a method for generating and displaying conformal overlays for detected objects within the field of view of the wearable display device.

FIG. 6A is an example of a field of view through the wearable display device without any displayed overlays.

FIG. 6B is a screenshot of the field of view of FIG. 6A with conformal overlays displayed on detected objects and a graphical arrow displayed to indicate a navigational route for the host vessel.

FIG. 6C is a screenshot of the field of view of FIG. 6A displaying additional information for a nearby vessel in response to a user input selection.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

A major disadvantage of nearly every marine electronic navigation device introduced to date is the necessity for the navigator to turn his or her attention away from the view outside the bridge windows, even momentarily. Head-Up Display systems are designed to provide a user with a display that allows him or her to view objects and cues in the real world scene (the far domain) concurrently with the presentation of additional information—for example, information from on-board instruments and displays (the near domain). The real-world display can be a direct view of the real-world scene or a video rendered version of that scene. HUDs have not been effectively developed for commercial maritime use to date, largely due to prohibitive cost factors and technology limitations and to date have also not yet leveraged non-video overlaid versions of HUDs using conformal information.

HUDs may in fact hold one of the keys to the effective application of the wide-ranging, ambitious demands placed on command and control of commercial, military and pleasure craft of the future. There are various types of HUDs to include fixed position, as well as various versions of head, or helmet-mounted displays (HMD). The HMD's also include concepts such as augmented reality glasses or augmented reality telescopes and binoculars. The information can be presented either monocularly (one eye) or binocularly (two eyes)

There are several important concepts to understand when designing or evaluating a real-world HUD system and these can be impacted by the hardware and software options available, as well as the situational constraints. The first is the eyebox, which is the 3-dimensional envelope that the user can be positioned in from which the HUD information can be accurately viewed. The eye-box and accurate viewing are especially important for conformal information that requires alignment of the presented information with real-world objects. Mariners typically are walking around the bridge rather than seated in a stationary position like aviators or automobile drivers, which provides an additional design challenge to any fixed position systems and an advantage to HMDs.

The second concept, the field of view (FOV), is the spatial angle (lateral and vertical cone or wedge) in which HUD information is presented. For instance HUD information could be provided only within 18, 30, 90, etc. horizontal/vertical degrees in front of the viewer. When designing a HUD it is essential to consider what the available HUD FOV is and how that compares to the overall FOV utilized by the operators. For HMDs this field of view moves with the user, but this can also add challenges for the display rendering to keep up with rapid movements.

The third is the contrast ratio, which is the ratio of the display information brightness to the external visual cue brightness and is impacted by the ambient brightness level. Consideration must also be given to various sources of potential discrepancies, disparities, and alignment issues, including distortion and displacement errors, as well as by differences in the apparent position of images as presented to each eye, different viewing positions, or multiple viewers.

Overall, increased “eyes out the window” time is seen as a primary advantage of a HUD system. Keeping an operator's eyes on the outside visual scene reduces the probability that a critical real-world event will be missed. The ability to present conformal imagery is also seen as one of the primary advantages of a HUD. Another primary HUD advantage found in the literature is reducing the amount of scanning, reaccomodation, and head movement required in order to utilize both near and far domain information. This benefit can be realized with non-conformal HUD information as well (i.e., speed, notification or aids for required actions such as shifting or turning, targeting information, etc.) and becomes a greater advantage in high-speed operations when risk dramatically increases and the operator removes his or her view from the outside world to retrieve this information. A further reduction in the time it takes to integrate this information can be produced by the intelligent design and placement of HUD information in reference to the outside visual cues. For maritime operations the focal point to optimally utilize HUD information would be to focus the information at optical infinity (>9 meters) as nearly all external information of interest to a mariner is greater than 9 meters away.

The potential for clutter is one of the primary risks or disadvantages with HUD presentation. This risk, and the related cost, increases as more information is added to the HUD. There are two basic types of clutter. The first type results in increased time to search and find a specific item of information. This same disadvantage also occurs with information presented through normal head down displays. The second type is due to irrelevant information items overlapping (obscuring) or interfering with (masking) the perception or interpretation of target information items. Another risk often presented in the HUD literature is attentional tunneling, where the HUD related information captures the operator's attention and he or she misses important information in the outside world, or from the on-board environment. The design of the HUD information portrayal is critical to minimizing these risks.

In some implementations, a marine navigation system is configured to use a wearable display device such as see-through Augmented Reality Glasses (current examples include the Microsoft Hololens and Epson Moverio but the design concept is intended to support future AR Glasses equipment as well) to provide critical information to support maritime navigation. This set up can also be considered a head-mounted display, or helmet mounted display (HMD). These display devices can provide information to one eye (monocular) or both eyes (binocular) displays respectively. The display of information is powered by software executed by an electronic controller connected to the HMD either via a wire or wirelessly (E.g., such as via blue tooth or wifi).

This information will be presented in the moving Field of View of the user, georeferenced to the user and vessel's position in space, time and viewing angle to allow the conformal presentation of information items whose meaning and usefulness is enhanced by being accurately located in the environment. This for example could be the location of hazards or routes in their correct locations. Other items will be georeferenced to an object, such as the names of other vessels to be attached to location and symbology for the target vessel as could be received through interface with the Automatic Identification System (AIS). Other items of information will not need to be geo-referenced in their display portrayal as this is not relevant (e.g., speed, heading, etc.) and will be optimally portrayed in an easy to use but not obtrusive location (e.g., out of the primary field of view)

The software will leverage a variety of both onboard and internal sensors to accurately represent the vessel and ship location. This might include the vessel's position, navigation and timing information from ship systems; the HMD's position, navigation and timing information from sensors such as magnetometers, accelerometers and gyroscopes, etc.; inertial navigation systems, and external tracking devices, such as line of motion sensing devices such as Microsoft Kinect.

The accurate geolocation of the user will allow the software to properly select and render 3d graphics and information from databases connected to the device, both internal and from onboard equipment. These include various chart objects, such as routes and navigation markers and hazards that will be automatically converted and portrayed as 3D augmented reality conformal information, or otherwise how most appropriate.

The system is configured to promote the mariners situational awareness by reducing head down time and yet maintaining a clear view and look out on the outside world. Essential to this is the careful design to reduce display clutter by only presenting the minimal core information required by the voyage stage, task and context. Therefore the system is designed to acquire this task and contextual information from a combination of pre-programmed intelligence, the use of data provided by ship systems, and timely and user-friendly mariner input.

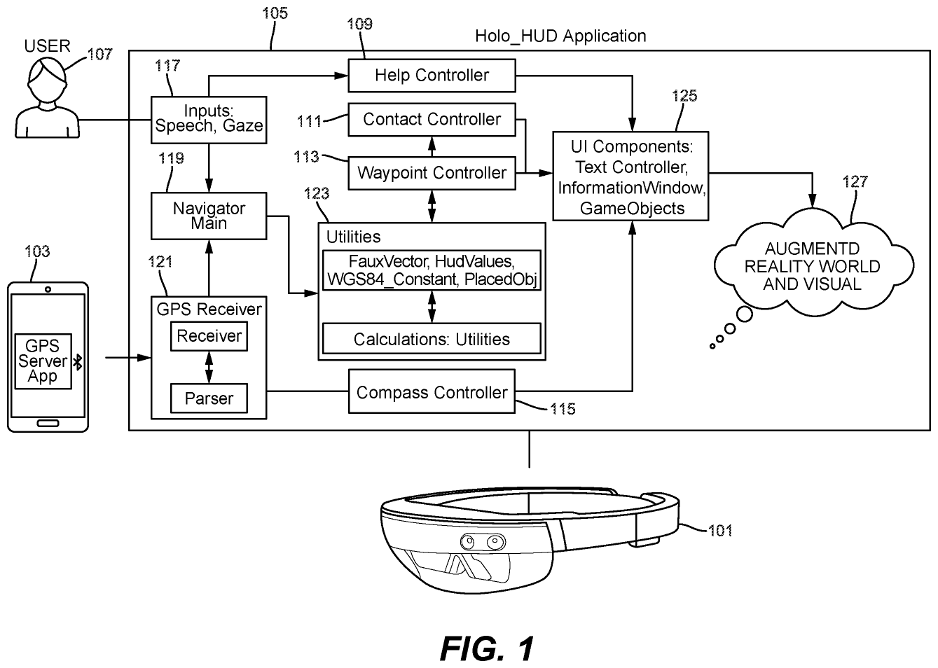

FIG. 1 illustrates one example of a system that includes a Hololens or similar HMD device (i.e., wearable display device 101), and an external global positioning system device (GPS 103) that has GPS Beacon Application installed. Software executed by a controller 105 that provides the functionality of the system includes:

Holo_HUD Application (running on controller 105)—The main application that handles the GPS input and turns it into a navigable trackline superimposed over the user's field of view

GPS Server Application (running on GPS device 103)—“GPSBeacon”—An auxiliary application that advertises the GPS data requested by the controller 105.

The wearable display device 101 includes a display screen that is at least partially transparent. In the example of FIG. 1, the wearable display device 101 is in the form of eye glasses that are worn on the head of a user 107. Graphical and textual data is projected onto the display screen to appear overlaid onto the user's view of the real-world. The Holo_HUD for Maritime system is a Heads-Up-Display system that uses GPS data and predetermined & real-time adaptable routes to create a track superimposed on the real world through the user's display. The Holo_HUD for Maritime system allows users to augment a predetermined route on their field of view within the wearable display device 101—an augmented reality device, in full 3D as well as show necessary navigational information within the same display as the position location changes and interact with objects within the augmented world.

The Holo_HUD software application as illustrated in the example of FIG. 1 is implemented as computer-executable instructions stored on a non-transitory computer-readable memory. The instructions are accessed from the memory and executed by one or more electronic processors to provide the functionality such as described herein. In some implementations, the electronic processor and the memory are incorporated into the wearable display device. In other implementations, the electronic processor and the memory are provided as a separate control device that is communicatively coupled to the wearable display device (e.g., a tablet computer, a smart phone, or an application specific computing device carried/worn by the user).

As illustrated in the example of FIG. 1, the Holo_HUD application software provides multiple different “control” processes including, for example, a Help Controller 109 (configured to provide on-screen help functionality for a user), a Contact Controller 111, a Waypoint Controller 113 (configured to track and maintain a list of waypoints forming a navigational route), and a Compass Controller 115 (configured to determine a geospatial position of the host vessel & the wearable display device 101 and an orientation of the wearable display device 101).

The system of FIG. 1 is also configured with one or more user input mechanism including, for example, a camera configured to monitor the direction of the user's eyes and/or the orientation of the wearable display device 101 to detect a user's “gaze” as a control input. In some implementations, the system also includes a microphone configured to receive speech inputs from the user 107. As illustrated in FIG. 1, the electronic controller is configured to receive the user command inputs 117 and to operate a main navigation program functionality (i.e., navigator main 119). The main navigator program 119 also operates based on input data received from the GPS 103 through a GPS receiver 121. The geospatial position signal indicated by the GPS 103 is also provided as input to the compass controller 115. The software also executes a variety of utility programs 123 including, for example, a mechanism by which the waypoints tracked and maintained by the waypoint controller 113 are adjusted and utilized by the main navigator program 119. Finally, the electronic controller is configured to generate graphical and/or textual information which provide the graphical user interface components 125 which displayed on the display screen of the wearable display device 101 as the “Augmented Reality World” 127.

In some implementations, a route for the host vessel is created outside of the application similar to how mariners plan their routes before plugging them in on their electronic charting display. This system has the ability to: (i) Load waypoint files (.XML) into the system and uses them to create tracks, (ii) Use Bluetooth to connect to an external GPS device, (iii) Pull up waypoint information during runtime, (iv) Perform compass functions, (v) Display and update in real time essential navigational information, (vi) Recognize certain phrases using speech and gestures to invoke commands, and (vii) Use user's gaze as cursor to point out an object.

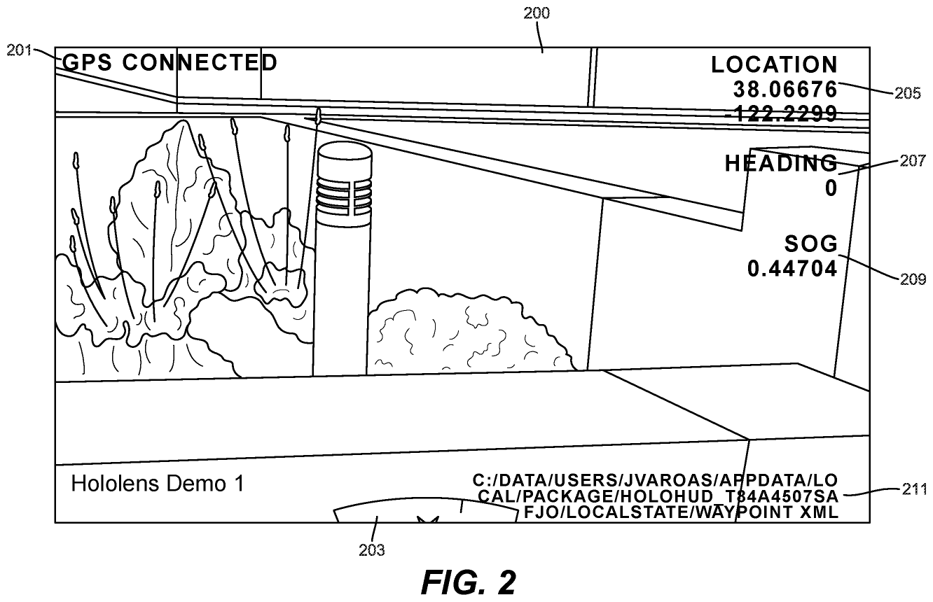

As illustrated in FIG. 2, in addition to the conformal Augmented Reality graphical information presented (waypoints and tracklines) as described in further detail below, the graphical user interface 200 shown on the device will provide the user with alphanumeric navigational data such as: (i) GPS Status 201 is displayed on top left edge of display, (ii) Compass 203 is in the bottom center of display (showing the compass direction in which the wearable display device 101 is currently facing), (iii) Location Data 205 is on top right edge of display, (iv) Heading 207 (i.e., the direction in which the host vessel is facing) is below the location data on the display, (v) Speed over Ground (SOG) 209 is in the center of the right edge of the display, and (vi) Waypoint File Path 211 is in bottom right edge of display.

Additionally, this system maintains maritime principles in deciding color schemes that are necessary indicators for mariners in navigation. The system is expected to change in future releases with more functionality and options such integration of AIS target data, radar superimposition, Rules of the Road advisor etc.

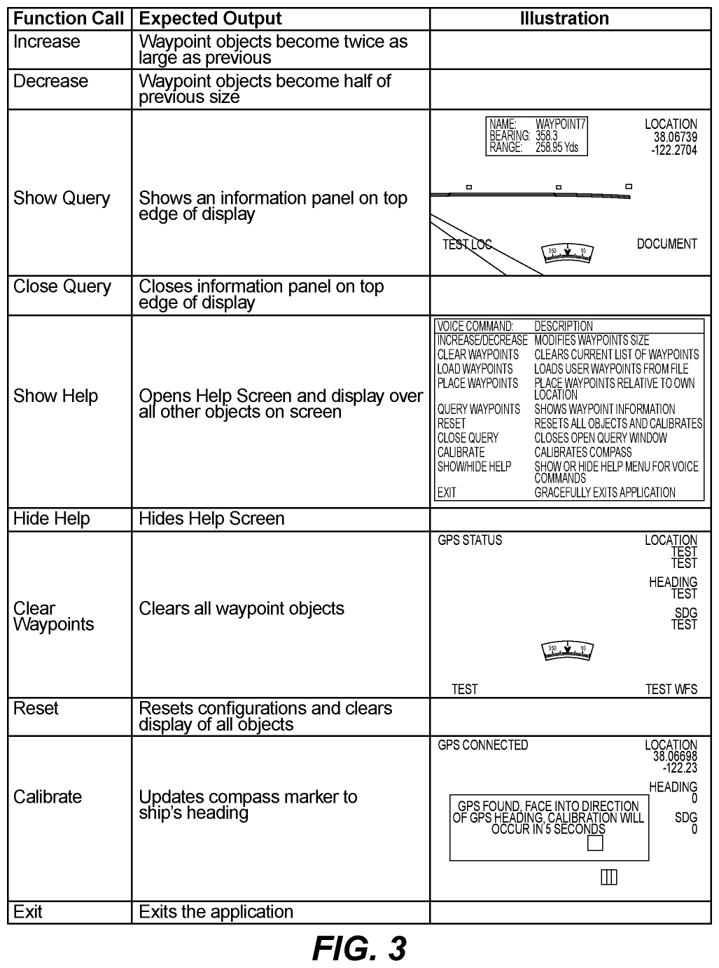

The system allows for verbal commands to manipulate the information displayed as shown in Table 1 of FIG. 3.

In some implementations, the system is configured to generate and display graphical elements overlaid onto the real-world field-of-view of the HMD that are indicative of a planned navigational route for the host vessel (i.e., a marine vessel associated with the HMD worn by a user aboard the marine vessel). Furthermore, the system may be configured to receive information from other nearby marine vessels (e.g., AIS data) and to display graphical and/or textual elements on the display based on the received information. For example, the system may be configured to receive AIS (“automatic identification system”) data from a nearby vessel indicating a unique identifier (or “name”) associated with the vessel, an identification of the type of marine vessel, and an indication of a current position, course, and speed of the nearby marine vessel. In some implementations, the system is configured to access a three-dimensional graphical representation of a shape of the nearby vessel from memory based on the identification of the type of marine vessel. The system is further configured to then display the three-dimensional graphical representation on the HMD at a location corresponding to the indication of the current position of the nearby marine vessel received via the AIS data. In this way, the system is able to display the three-dimensional graphical representation as a conformal overlay onto the actual view of the other marine vessel in the real-world field-of-view. In some implementations, the system is configured to also display textual information regarding the other marine vessel.

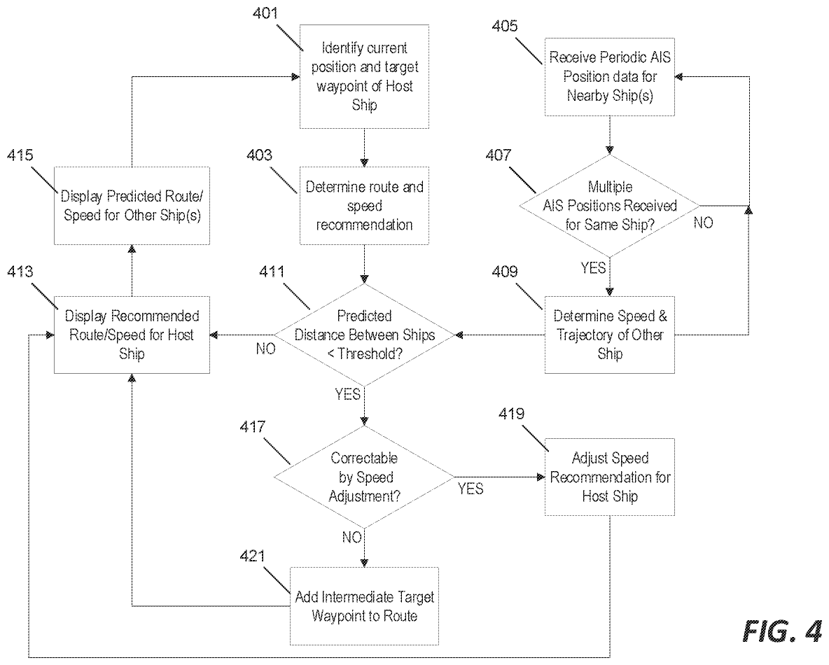

Furthermore, in some implementations, the system is further configured to automatically determine a navigational route for the host vessel and to update/alter the navigational route based on a determined position and estimated routes of the other nearby marine vessels. FIG. 4 illustrates one example of a method for automatically altering the navigational route of the host vessel based on AIS data received from other nearby marine vessels. The system identifies a current position and a target waypoint of the host ship (step 401) and then determines a route & speed recommendation for travel to the target waypoint (step 403). The system also receives periodic AIS position data for one or more nearby ships (step 405). The system monitors this incoming data to determine whether multiple different AIS positions are received for the same ship (step 407), which would indicate that the nearby ship is moving. If the periodically received AIS position data for a nearby ship indicates that the nearby ship is moving, the system determines a speed and trajectory of the other nearby ship based, for example, on the changes in the AIS position data received for that ship (step 409).

After determining a recommended route & speed for the host ship and estimating a speed & trajectory for the other ship, the system determines a predicted minimum distance between the two ship (i.e., how close the host ship will come to the other nearby ship if both ships continue on their current trajectories at their current speed). If that predicted minimum distance exceeds a defined safe distance threshold (step 411), then graphical and/or textual elements indicative of the determined route & speed recommendation for the host ship are displayed on the HMD (step 413) and, in some implementations, graphical/textual elements indicative of the estimated route/speed of the other nearby ship is also displayed on the HMD (step 415). In some implementations, in addition to or instead of the system being configured to estimate the trajectory of other nearby ships, the system may be configured to exchange and/or confirm planned routes with the other nearby ships. Additionally, in some implementations, the system may be configured to display additional information relating to the other nearby ships including, for example, contact information for a target vessel and may be configured to facilitate two-way communication with the target vessel.

However, if the system determines that the distance between the host ship and the other nearby ship will fall below the safe distance threshold if the vessels both continue on their current trajectory/speed (step 411), then the system evaluates whether the distance between the ships can be adjusted to a safe distance by a speed adjustment alone (step 417) (e.g., what host ship speed would be necessary to maintain a safe distance and is it possible for the host ship to adjust its speed to that degree in time?). If a safe distance between the ships can be attained by a speed adjustment, then the system will adjust the speed recommendation for the host ship accordingly (step 419) before displaying the recommended route/speed for the host ship on the HMD (step 413). However, if the system determines that a speed adjustment alone would be insufficient to maintain a safe distance between the host ship and the other nearby ship, then the system adds an intermediate target waypoint to the route (step 421). In some implementations, the intermediate waypoint is presented to the operator of the host ship as a recommendation, but the actual trajectory or speed of the host vessel does not change until/unless the operator accepts/approves the recommended adjustment. In other implementations, the system may be configured to implement the recommended adjustment automatically without the need for human/operator intervention. The addition of the intermediate waypoint will cause the host ship to adjust its trajectory to a degree that is sufficient to maintain a safe distance between the host ship and the other nearby ship.

Although the explanation of this example above involves only a host ship and one other nearby ship, the system may be configured to estimate speed & trajectory for multiple different nearby vessels concurrently, to determine the minimum distance predictions between the host ship and each of the multiple different nearby vessels, and to adjust the speed & add intermediate waypoints as necessary to ensure a safe distance is maintained between the host ship and all of the other nearby vessels detected and tracked by the system.

Similarly, in some implementations, the system may be configured to display on the HMD the conformal overlay image for multiple different nearby vessels at the same time and to display the estimated routes for the multiple different nearby vessels at the same time. In some such implementations, the system may be configured to provide a user interface that allows a user to selectively display and remove displayed navigational paths for one or more of the multiple nearby vessels. For example, in some implementations, the system is configured to detect a user's hand movement selecting and/or deselecting an individual conformal overlay corresponding to one of the nearby ships. In response to receiving a first selection of the nearby ship, the system displays graphical and/or textual elements indicative of the current speed and trajectory of the selected nearby ship. In response to receiving a second selection of that same nearby ship, the system “de-selects” the ship and removes the displayed graphical/textual elements indicative of the current speed and trajectory of the de-selected nearby ship. In this way, the user can alternatingly select and de-select the nearby ships for which trajectory and speed information is displayed on the HMD. In addition to or instead of providing a mechanism for selecting and/or deselecting a target vessel for display, in some implementations, the system may be configured to automatically determine which nearby ships and which information is most relevant to the current operation of the host vessel and to display only the automatically selecting information so as to decrease clutter in the display. For example, the system may be configured to automatically display information and/or routes for other nearby ships that, based on currently available information, are determined to be have a current route/trajectory that will place that other ship within a defined distance threshold of the host vessel

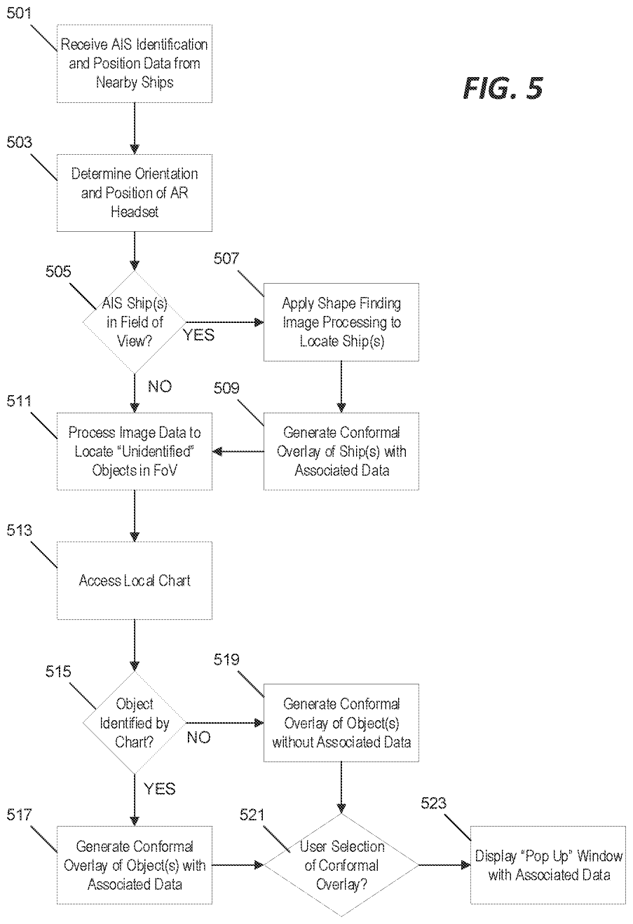

FIG. 5 illustrates an example of a method executed by the system of FIG. 1 for determining the position and identity of objections nearby the host vessel and for displaying information regarding those detected nearby objects on an AR headset (e.g., the wearable display device 101). First, the system receives AIS data from nearby ships including both an identification and a position/course/speed of each nearby ship (step 501). The system then determines the orientation and position of the AR headset (step 503) and determines whether any of the nearby ships are expected to be positioned within the field of view of the AR headset (step 505). If so, image processing is applied to image data captured by the AR headset (i.e., by a forward-facing camera incorporated into the AR headset) to detect the ships in the captured image data and to determine their apparent position relative to the perspective of the AR headset (step 507). The system then generates a conformal overlay corresponding to the shape, size, position, and orientation of the nearby ship and displays the conformal overlay on the display screen of the AR headset so that the conformal overlay appears as an overlay over the real-world ship (step 509). The system also stores associated data for the nearby ship (e.g., the unique identifier, ship type, origin, destination, position, course, speed, etc.) which can then be accessed and viewed by a user on the AR headset.

In some implementations, the system is also configured to apply image processing to detect other objects in the field of view of the AR headset (step 511) including, for example, objects other than any nearby ships that were identified by received AIS data. In some implementations, the system is configured to determine an estimated geospatial position of any detected objects based on the position/orientation of the AR headset and the relative position of the detected objects in the image data. The system then accesses one or more local charts for the area (step 513) and determines whether the chart identifies any objects at the estimated location of the detected object (e.g., lighthouse, buoy, etc.). If the detected object can be identified based on the information from the chart (step 515), then the system will generate & display a conformal overlay of the detected object and store associated data for the identified object that can be accessed/viewed by the user on the display screen of the AR headset (step 517). However, if the object cannot be identified, the system will still attempt to generate & display a conformal overlay without any additional associated data accessed from other sources (step 519). In some implementations, the system may be configured to attempt to identify the unidentified object(s) using image processing techniques such as edge-detection and shape-matching processing. Also, in some implementations, the system may be configured to store and display information that can be determined by the system for unidentified objects including, for example, a distance between the host vessel and the unidentified object.

As discussed above, the system may be configured to receive a user input command based, for example, on the gaze direction or hand movements of the user. In some implementations (as illustrated in the example of FIG. 5), the system may be configured to detect a user selection of one of the displayed conformal overlays (step 521). In response to detecting a user selection of an object with a displayed conformal overlay, the system will display a “pop up” window on the display screen of the AR headset listing additional associated data for the object corresponding to the selected conformal overlay.

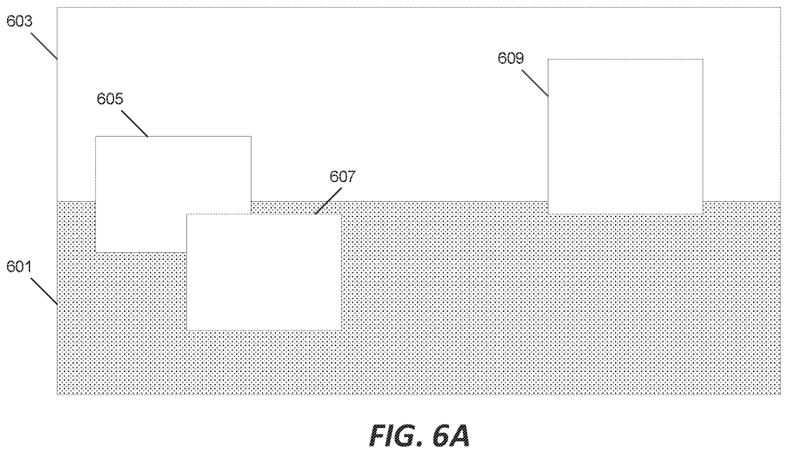

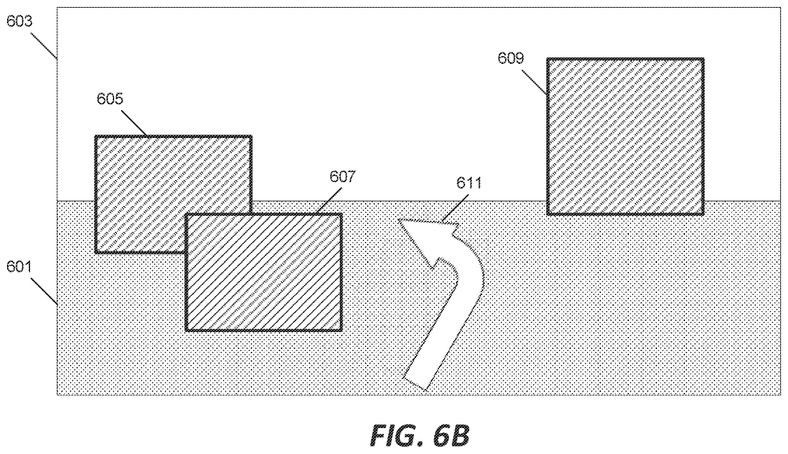

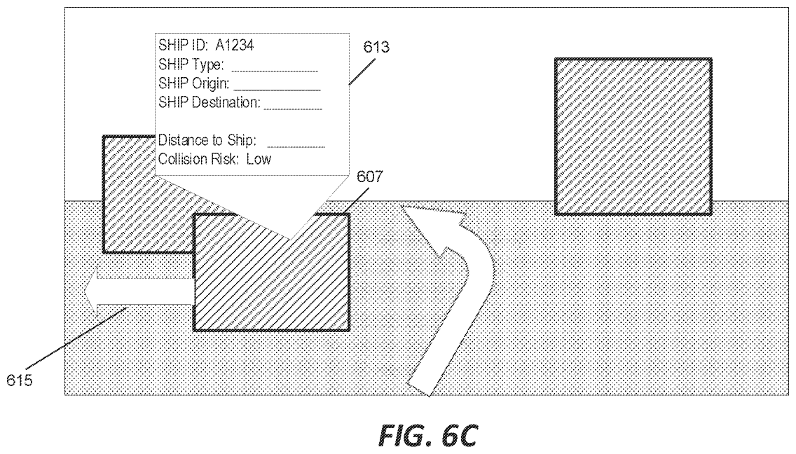

FIG. 6A illustrates an example of a scene of real-world objects that might be visible to a user of the system of FIG. 1 through the AR headset (i.e., the wearable display device 101). The scene of real-world objects within the field of view of the AR headset includes a water surface 601 and a sky 603 above the horizon. Three objects (e.g., a first ship 605, a second ship 607, and a third ship 609) are also visible within the field of view of the AR headset. As discussed above in reference to FIGS. 4 and 5, the system is configured to receive AIS data from each of these three nearby ships, to reroute a navigational path of the host vessel (if necessary), and to display a conformal overlay corresponding to each of the three ships 605, 607, 609.

FIG. 6B illustrates an example of the same scene of real-world objects as in FIG. 6A, but with graphical display elements also shown on the display screen of the AR headset. In the example of FIG. 6B, conformal overlays are displayed as graphics approximating the position and apparent size of each of the nearby ships 605, 607, 609 and highlight the ships to make them more visible to the user through the AR headset. The display screen of the AR headset also displays an arrow 611 representing the current navigational route of the host vessel. In the example of FIG. 6B, the navigational route 611 will direct the host vessel to move to the right of ship 607 and then to turn to the left between ship 605 and ship 609.

As described above, the system is configured to detect a user selection of one of the conformal overlays (e.g., based on a gaze direction or a hand movement/gesture). FIG. 6C illustrates an example of the graphical user interface shown on the display screen of the AR headset in response to a user selection of the conformal overlay corresponding to ship 607. As shown in FIG. 6C, a pop-up window 613 is displayed on the screen listing various textual information regarding ship 607 including a unique identifier of the ship (i.e., a “ship ID”), an indication of the type of ship, the origin of the ship, the destination of the ship, a distance between the ship 607 and the host vessel (as determined, for example, based on the GPS data for the host vessel and the AIS data from the ship 607), and an indication of a collision risk between the host vessel and the ship 607. In the example of FIG. 6C, the user selection of the conformal overlay for ship 607 also causes the system to display an arrow 615 indicating a current navigational route of the selected ship 607. As illustrated in the example of FIG. 6C, the ship 607 is moving to the left relative to the host vessel and, therefore, is moving further out of the navigational route for the host vessel.

It is again noted that at least some of the graphical and textual elements displayed by the AR headset are associated with 3D positions within a virtual environment. Accordingly, when the user moves their head (and, therefore, also adjusts the orientation and/or position of the AR headset changing its field-of-view), the position of at least some graphical display elements on the display screen of the AR headset is also changed such that the graphical display elements continue to be displayed in their appropriate 3D positions. For example, in the example of FIG. 6B, if the user's head is tilted upward, the system will move the displayed position of the conformal overlay for ship 605 downward on the display screen of the AR head set so that the conformal overlay for ship 605 remains positioned over the user's perspective view of the actual ship 605. Also, in some implementations, the size and orientation of the conformal overlays may also be adjusted by the system based on relative movements of the host vessel and/or the object in the field of view. Similarly, because the graphical depiction of the navigational route 611 is also associated with a specific 3D position in the virtual display environment, the position, orientation, and/or size of the graphical depiction of the navigational route 611 will be moved on the display screen of the AR headset as the user's head moves. When the user's head moves such that the navigational route is no longer within the field of view in the AR headset, then the graphical depiction of the navigational route 611 is no longer displayed on the display screen of the AR headset.

Accordingly, various examples described herein provide systems and methods for augmented reality-based marine navigation. Various features and advantages of the invention are also set forth in the following claims.

What is claimed is:

1. A method for augmented-reality-based marine navigation, the method comprising:
plotting, by an electronic controller, a navigational route between a current geospatial position of a host vessel and a target destination of the host vessel, wherein the navigational route is plotted as a series of waypoints;
receiving, by the electronic controller from at least one nearby ship, an electronic transmission indicative of a current position of the at least one nearby ship;
updating, by the electronic controller, the navigational route based at least in part on the electronic transmission received from the at least one nearby ship; and
displaying on a head-worn augmented reality display device a graphical representation of the updated navigational route and a graphical indication of the current position of the at least one nearby ship.

2. The method of claim 1, wherein updating the navigational route includes adding at least one new intermediate waypoint to the navigational route to maintain a defined minimum distance between the host vessel and the at least one nearby ship.

3. The method of claim 2, wherein receiving the electronic transmission from the at least one nearby ship further includes receiving an electronic transmission including an indication of a navigational route of the at least one nearby ship and a speed of the at least one nearby ship, the method further comprising:
determining, by the electronic controller, whether the navigational route of the at least one nearby ship will intersect a current navigational route of the host vessel;
determining, based on the indicated speed of the at least one nearby ship, an estimated time when the at least one nearby ship will be positioned within the current navigational route of the host vessel; and
determining, based on a current speed of the host vessel, whether a distance between the host vessel and the at least one nearby ship will be less than the defined minimum distance if the host vessel continues to operate on the current navigational route, and
wherein updating the navigational route based at least in part on the electronic transmission received from the at least one nearby ship includes updating the current navigational route in response to determining that the distance between the host vessel and the at least one nearby ship will be less than the defined minimum distance if the host vessel continues to operate on the current navigational route.

4. The method of claim 1, wherein displaying on the head-worn augmented reality display device the graphical indication of the current position of the at least one nearby ship includes displaying a conformal overlay of the at least one nearby ship on a screen position of the head-worn augmented reality display device corresponding to a relative position of the at least one nearby ship.

5. The method of claim 4, wherein receiving the electronic transmission from the at least one nearby ship further includes receiving an electronic transmission providing a unique identifier of the at least one nearby ship, and
wherein displaying the graphical indication of the current position of the at least one nearby ship includes selecting a predefined conformal overlay shape corresponding to the at least one nearby ship based on the unique identifier.

6. The method of claim 1, further comprising:
determining, by the electronic controller, a geospatial location and orientation of the head-worn augmented reality display device;
determining a geospatial area corresponding to a field of view of the head-worn augmented reality display device;
accessing a navigational chart;
identifying, based on the navigational chart, one or more stationary objects within the geospatial area corresponding to the field of view of the head-worn augmented reality display device; and
displaying on the head-worn augmented reality display device a graphical indication of a position of the one or more stationary objects within the geospatial area corresponding to the field of view of the head-worn augmented reality display device.

7. The method of claim 6, wherein displaying on the head-worn augmented reality display device the graphical indication of the position of the one or more stationary objects includes displaying on the head-worn augmented reality display device a conformal overlay of the one or more stationary objects at a screen location on the head-worn augmented reality display device corresponding to a relative position of the one or more stationary objects.

8. The method of claim 1, further comprising:
receiving, by the electronic controller, a user input selecting a graphical indication of a first nearby ship displayed on the head-worn augmented reality display device; and
displaying, in response to the user input selection, additional textual information relating to the first nearby ship, wherein the displayed additional textual information includes additional information communicated by the first nearby ship through the electronic transmission.

9. The method of claim 8, wherein receiving the user input selecting the graphical indication of the first nearby ship displayed on the head-worn augmented reality display device includes receiving at least one selected from a group consisting of a speech input command detected by a microphone, a gaze direction command, and a hand gesture command detected by a camera.

10. The method of claim 8, wherein the additional textual information displayed includes at least one selected from a group consisting of a unique identifier of the first nearby ship, an indication of the current position of the first nearby ship, a current speed of the first nearby ship, and a current direction of movement of the first nearby ship.

11. The method of claim 1, wherein receiving, by the electronic controller from the at least one nearby ship, the electronic transmission indicative of the current position of the at least one nearby ship includes receiving an automatic identification system (AIS) transmission from the at least one nearby ship.

12. An augmented-reality-based marine navigation system comprising:
a head-worn augmented reality display device including an at least partial transparent display screen configured to display graphical and textual elements visible over a real-world field of view; and
an electronic controller configured to
plot a navigational route between a current geospatial position of a host vessel and a target destination of the host vessel, wherein the navigational route is plotted as a series of waypoints;
receive, from at least one nearby ship, an electronic transmission indicative of a current position of the at least one nearby ship;
update the navigational route based at least in part on the electronic transmission received from the at least one nearby ship; and
display on a head-worn augmented reality display device a graphical representation of the updated navigational route and a graphical indication of the current position of the at least one nearby ship.

13. The system of claim 12, wherein the electronic controller is configured to update the navigational route by adding at least one new intermediate waypoint to the navigational route to maintain a defined minimum distance between the host vessel and the at least one nearby ship.

14. The system of claim 13, wherein the electronic controller is further configured to:
determine, based on the electronic transmission received from the at least one nearby ship, whether a navigational route of the at least one nearby ship will intersect a current navigational route of the host vessel,
determine, based on an indicated speed of the at least one nearby ship, an estimated time when the at least one nearby ship will be positioned within the current navigational route of the host vessel, and
determine, based on a current speed of the host vessel, whether a distance between the host vessel and the at least one nearby ship will be less than the defined minimum distance if the host vessel continues to operate on the current navigational route, and
wherein the electronic controller is configured to update the navigational route based at least in part on the electronic transmission received from the at least one nearby ship by updating the current navigational route in response to determining that the distance between the host vessel and the at least one nearby ship will be less than the defined minimum distance if the host vessel continues to operate on the current navigational route.

15. The system of claim 12, wherein the electronic controller is configured to display on the head-worn augmented reality display device the graphical indication of the current position of the at least one nearby ship by displaying a conformal overlay of the at least one nearby ship on a screen position of the head-worn augmented reality display device corresponding to a relative position of the at least one nearby ship.

16. The system of claim 15, wherein the electronic controller is configured to receive the electronic transmission from the at least one nearby ship by receiving an electronic transmission providing a unique identifier of the at least one nearby ship, and
wherein the electronic controller is configured to display the graphical indication of the current position of the at least one nearby ship by selecting a predefined conformal overlay shape corresponding to the at least one nearby ship based on the unique identifier.

17. The system of claim 12, wherein the electronic controller is further configured to
identify, based on a current geospatial location and orientation of the head-worn augmented reality display device and at least one accessed navigational chart, one or more stationary objects within a geospatial area corresponding to a field of view of the head-worn augmented reality display device; and
display on the head-worn augmented reality display device a conformal overlay of the one or more stationary objects at a screen location on the head-worn augmented reality display device corresponding to a relative position of the one or more stationary objects.

18. The system of claim 12, wherein the electronic controller is further configured to:
receive a user input selecting a graphical indication of a first nearby ship displayed on the head-worn augmented reality display device, and
display, in response to the user input selection, additional textual information relating to the first nearby ship,
wherein the displayed additional textual information includes additional information received from the first nearby ship through the electronic transmission,
wherein the electronic controller is configured to receive the user input selecting the graphical indication of the first nearby ship displayed on the head-worn augmented reality display device by detecting at least one selected from a group consisting of a speech input command detected by a microphone, a gaze direction command, and a hand gesture command detected by a camera, and
wherein the additional textual information displayed includes at least one selected from a group consisting of a unique identifier of the first nearby ship, an indication of the current position of the first nearby ship, a current speed of the first nearby ship, and a current direction of movement of the first nearby ship.

19. The system of claim 12, wherein the electronic controller is configured to receive, from the at least one nearby ship, the electronic transmission indicative of the current position of the at least one nearby ship by receiving an automatic identification system (AIS) transmission from the at least one nearby ship.
